(19) United States
(12) Patent Application Publication
(10) Pub. No.: US 2022/0058691 A1
(43) Pub. Date: Feb. 24, 2022

(54) INFORMATION PROCESSING APPARATUS, INFORMATION PROCESSING METHOD, AND NON-TRANSITORY COMPUTER-READABLE STORAGE MEDIUM

(71) Applicant: HONDA MOTOR CO., LTD., Tokyo (JP)

(72) Inventors: Ryo SAIKI, Tokyo (JP); Yohji ONOUE, Tokyo (JP)

(21) Appl. No.: 17/378,953

(22) Filed: Jul. 19, 2021

(30) Foreign Application Priority Data
Aug. 20, 2020 (JP) 2020-139431

(51) Int. Cl. G06Q 30/02; G06T 7/70; G06K 9/00

(52) U.S. Cl. CPC G06Q 30/0266; G06Q 30/0267; G06T 7/70; G06K 2209/21; G06K 9/00791; G06T 2207/30196; G06K 9/00302

(57) ABSTRACT

An information processing apparatus for distributing distribution information to a user apparatus, the information processing apparatus executing an information processing method comprising: specifying, based on image capturing data acquired by an image capturing device of a vehicle, a state of a person associated with the user apparatus at the time of image capturing; and distributing, to the user apparatus, distribution information selected from a plurality of pieces of distribution information based on the specified state of the person.

### CROSS-REFERENCE TO RELATED APPLICATION(S)

This application claims priority to and the benefit of Japanese Patent Application No. 2020-139431 filed on Aug. 20, 2020, the entire disclosure of which is incorporated herein by reference.

### BACKGROUND OF THE INVENTION

### Field of the Invention

The present invention relates to an information processing apparatus for distributing information of a user apparatus, an information processing method, and a non-transitory computer-readable storage medium.

### Description of the Related Art

There is known a technique of distributing information such as an advertisement via a vehicle. Japanese Patent No. 5601423 discloses a vehicle that presents an advertisement to many unspecified people based on the sales result of a product within a predetermined distance.

However, information that attracts the interest of each person changes depending on the state of the person at the time of receiving the information. If, for example, a person is alone, information concerning a diner or a book store can be suitable. On the other hand, if there is a group of people, information concerning a pub or a cafe can be suitable.

### SUMMARY OF THE INVENTION

The present invention has been made in consideration of the above problem, and provides a mechanism for distributing information to a user apparatus in accordance with the state of a person having the user apparatus.

According to the present invention, there is provided an information processing apparatus for distributing distribution information to a user apparatus, the information processing apparatus executing an information processing method comprising: specifying, based on image capturing data acquired by an image capturing device of a vehicle, a state of a person associated with the user apparatus at the time of image capturing; and distributing, to the user apparatus, distribution information selected from a plurality of pieces of distribution information based on the specified state of the person.

### BRIEF DESCRIPTION OF THE DRAWINGS

FIG. 1 is a schematic view of a communication system according to the first embodiment;

FIG. 2A is a hardware block diagram of a communication server according to the first embodiment;

FIG. 2B is a hardware block diagram of a vehicle according to the first embodiment;

FIG. 3A is a software block diagram of the communication server according to the first embodiment;

FIG. 3B is a software block diagram of the vehicle according to the first embodiment;

FIG. 4A is a table showing an example of user information held by the communication server according to the first embodiment;

FIG. 4B is a table showing an example of vehicle information held by the communication server according to the first embodiment;

FIG. 4C is a table showing an example of distribution information held by the communication server according to the first embodiment; and

FIG. 5 is a sequence chart showing an example of processing of the communication system according to the first embodiment.

### DESCRIPTION OF THE EMBODIMENTS

Hereinafter, embodiments will be described in detail with reference to the attached drawings. Note, the following embodiments are not intended to limit the scope of the claimed invention, and limitation is not made an invention that requires a combination of all features described in the embodiments. Two or more of the multiple features described in the embodiments may be combined as appropriate. Furthermore, the same reference numerals are given to the same or similar configurations, and redundant description thereof is omitted.

### First Embodiment

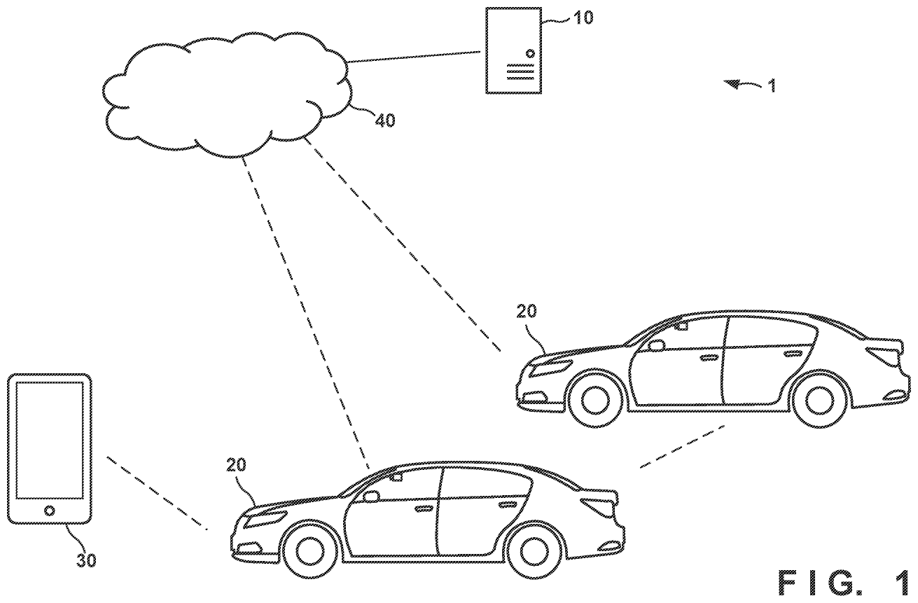

FIG. 1 is a schematic view of a communication system according to the embodiment of the present invention. A communication system 1 includes a communication server 10 and a vehicle 20, and distributes an advertisement to a user apparatus 30.

The communication server 10 is an information processing apparatus that stores distribution information such as advertisement information and determines which distribution information is to be distributed to the user apparatus 30. The communication server 10 can mutually communicate with the vehicle 20 and the user apparatus 30 via a network 40.

The vehicle 20 is a vehicle that includes an image capturing device and a communication unit, and can communicate with the communication server 10. This embodiment assumes that the vehicle 20 joins a mesh network but the vehicle 20 may be connected to the communication server 10 via an arbitrary network such as a cellular network, a Wi-Fi® network, or satellite communication.

The user apparatus 30 is an example of an information processing apparatus that receives a distribution information distribution service from the communication system 1. The user apparatus 30 includes at least one of information processing apparatuses of a smartphone, a tablet, a personal computer (PC), a smartwatch, and a tablet PC. This embodiment assumes that the user apparatus 30 can freely be connected to the Internet by joining the mesh network which the vehicle 20 joins but receives distribution of distribution information such as advertisement information.

The user apparatus 30 is associated with a user account for receiving provision of the service by the communication system 1. The user apparatus 30 includes a positioning sensor such as a GPS (Global Positioning System) sensor. Furthermore, the user apparatus 30 includes a display unit for presenting the distribution information to the user of the user apparatus 30 and an output unit such as a voice output unit.

(Hardware Arrangement)

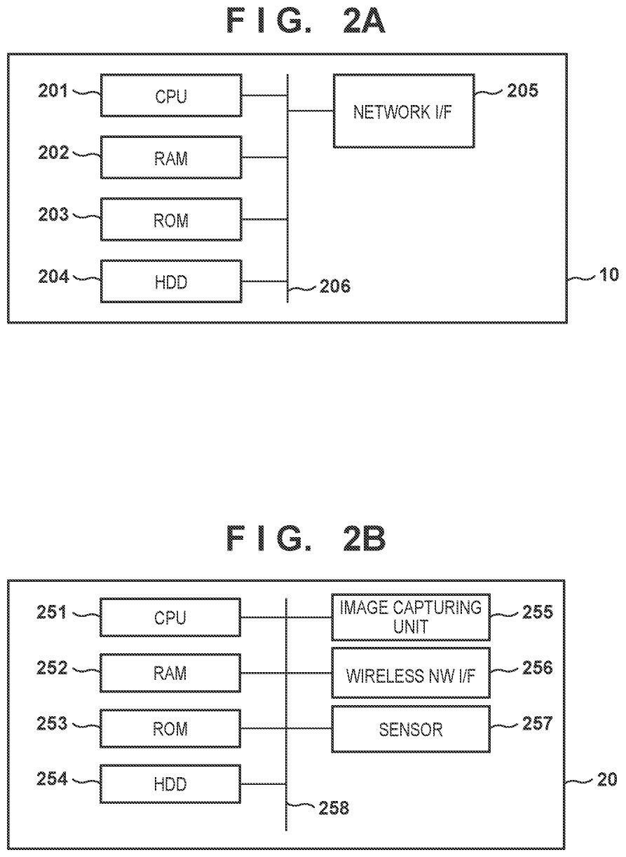

The hardware arrangement of the communication server 10 will be described with reference to FIG. 2A.

The communication server 10 includes a CPU (Central Processing Unit) 201, a RAM (Random Access Memory) 202, a ROM (Read Only Memory) 203, an HDD (Hard Disk Drive) 204, and a network interface (NW IF) 205. The respective portions are communicably connected to each other via an internal bus 206.

The CPU 201 controls the overall processing of the communication server 10. The RAM 202 is a volatile storage area, and is used as the work memory of the CPU 201 and the like. The ROM 203 is a nonvolatile storage area, and holds various programs to be executed by the CPU 201 and data. The HDD 204 is a nonvolatile storage area, and holds various data. The NW IF 205 controls communication with an external apparatus via an external network (for example, the network 40), and transmits/receives various data. The communication method here is not limited to a wired/wireless communication method and wired and wireless communication methods may be combined.

The hardware arrangement of the vehicle 20 will be described with reference to FIG. 2B. Note that only hardware components associated with an image data providing service according to this embodiment will be described with reference to FIG. 2B and a description of components such as the driving unit of the vehicle 20 will be omitted.

The vehicle 20 includes a CPU 251, a RAM 252, a ROM 253, an HDD 254, an image capturing unit 255, an NW IF 256, and a sensor 257. The respective portions are communicably connected to each other via an internal bus 258. The CPU 251 controls the overall processing of the vehicle 20. The RAM 252 is a volatile storage area, and is used as the work memory of the CPU 251 and the like. The ROM 253 is a nonvolatile storage area, and holds various programs to be executed by the CPU 251 and data. The HDD 254 is a nonvolatile storage area, and holds various data.

The image capturing unit 255 is an image capturing device including at least one of the camera of a drive recorder arranged in the vehicle 20, a front camera, a rear camera, and a side camera. The image capturing unit 255 may include a camera for automated driving or the camera of a portable terminal communicable with the vehicle.

The wireless NW IF 256 is a wireless communication unit capable of joining at least one of a wireless local area network (WLAN), a cellular network, and a multi-hop network to execute wireless communication.

The sensor 257 includes a positioning sensor such as a GPS (Global Positioning System) sensor.

(Software Arrangement)

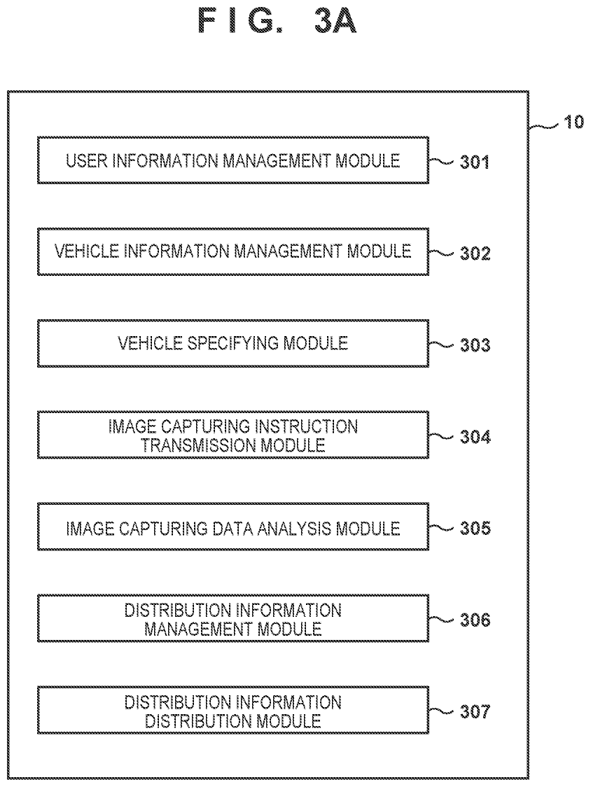

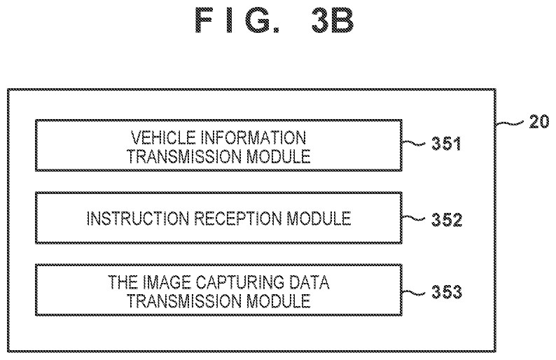

The software arrangement of the communication server 10 will be described with reference to FIG. 3A. The communication server 10 implements functions shown in FIG. 3A when the CPU 201 controls the NW IF 205 by executing the program stored in at least one of the ROM 203 and the HDD 204.

The communication server 10 includes a user information management module 301, a vehicle information management module 302, a vehicle specifying module 303, an image capturing instruction transmission module 304, an image capturing data analysis module 305, a distribution information management module 306, and a distribution information distribution module 307.

The user information management module 301 manages information concerning the user associated with the user apparatus 30.

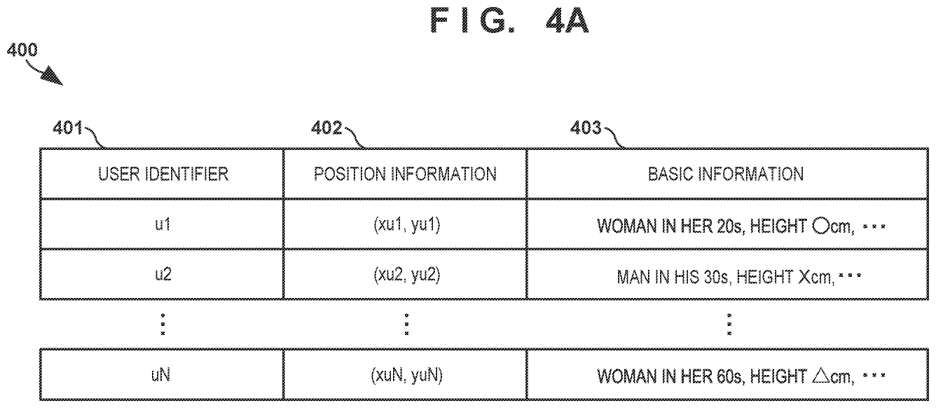

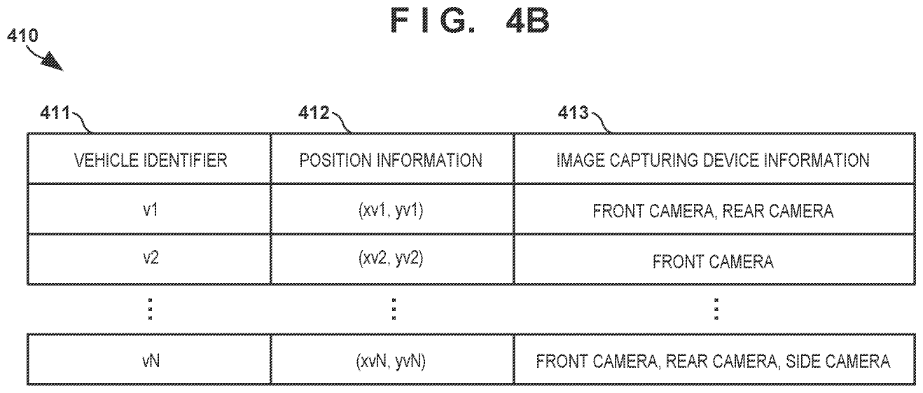

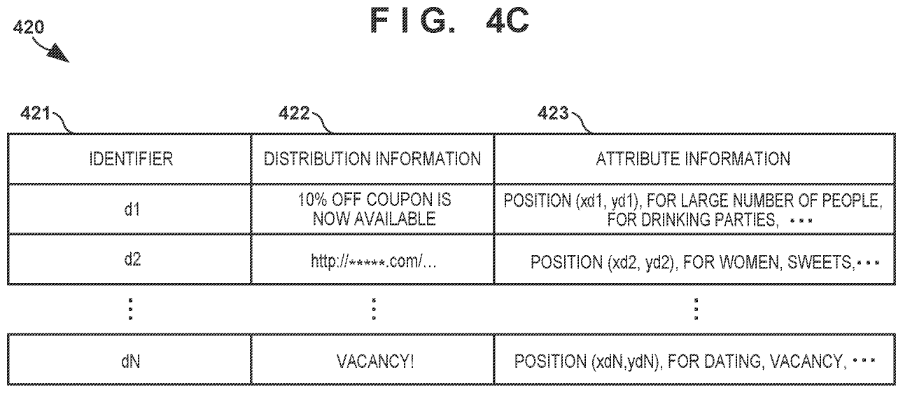

An example of a user information database (DB) 400 held by the communication server 10 will now be described with reference to FIG. 4A. The user information DB 400 includes a user identifier 401 and position information 402. In addition, the user information DB 400 optionally includes basic information 403. The user identifier 401 is information such as a user account capable of identifying the user having the user apparatus 30. The position information 402 corresponds to the position information of the user apparatus 30, and is periodically updated, as will be described later. The basic information 403 includes information concerning the appearance of the user. For example, the basic information 403 may include at least one of the age, sex, height, and weight of the user. Furthermore, the basic information 403 may include image data such as a face photo of the user.

The vehicle information management module 302 manages information concerning the vehicle 20.

An example of a vehicle information database (DB) 410 held by the communication server 10 will now be described with reference to FIG. 4B. The vehicle information DB 410 includes a vehicle identifier 411 and position information 412. In addition, the vehicle information DB 410 optionally includes image capturing device information 413 concerning the image capturing device provided in the vehicle 20. The vehicle identifier 411 is information such as the account of the owner of the vehicle 20, which can identify the vehicle 20. The position information 412 corresponds to the position information of the vehicle 20, and is periodically updated, as will be described later.

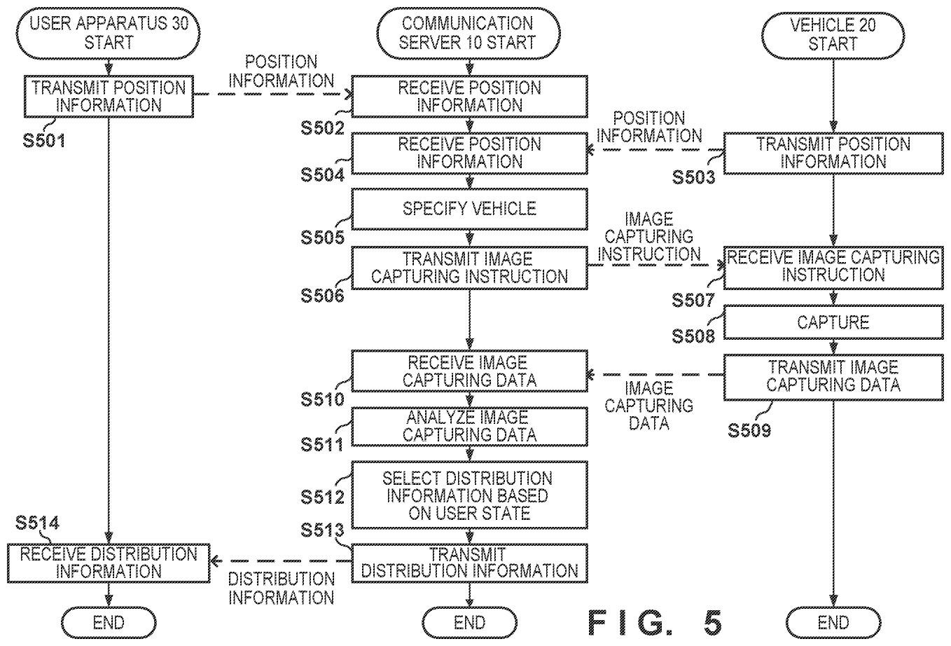

The vehicle specifying module 303 specifies a vehicle that requests to capture the person corresponding to the user apparatus 30. A vehicle specifying method will be described later with reference to FIG. 5.

The image capturing instruction transmission module 304 transmits, to the specified vehicle 20, an image capturing instruction of the person corresponding to the user apparatus. The image capturing data analysis module 305 acquires image capturing data from the vehicle 20 that has performed image capturing in response to the image capturing instruction, analyzes the image capturing data, and specifies the state of the person corresponding to the user apparatus.

The distribution information management module 306 manages distribution information that can be distributed to the user apparatus 30. If, for example, a distribution information registration request is received from an information apparatus installed in a store that desires to distribute the distribution information or the like, the distribution information management module 306 registers the distribution information in a distribution information database (DB). In another example, the operator of the communication system 1 may accept registration of the distribution information.

An example of a distribution information database (DB) 420 held by the communication server 10 will now be described with reference to FIG. 4C. The distribution information DB 420 includes an identifier 421, distribution information 422, and attribute information 423.

The identifier 421 is an identifier for each piece of distribution information. The distribution information 422 is information to be distributed to the user apparatus 30. For example, the distribution information may be discount information like distribution information “10% OFF coupon is now available” of an identifier d1. The distribution information 422 may be a URL (Uniform Resource Locator) like distribution information “http://*****.com/ . . . ” of an identifier d2. The distribution information may be information concerning the current state of a predetermined store or location like distribution information “vacancy” of an identifier dN. The distribution information may include not only text data but also at least one of moving image data and image data.

The attribute information 423 is attribute information concerning a user to which the distribution information is to be distributed or a store or location corresponding to the distribution information, which is used by the communication server 10 to select the distribution information to be distributed to the user apparatus 30. For example, the attribute information 423 may include the position information of a predetermined store or location. In this case, the attribute information 423 is used to distribute the distribution information to a user near the predetermined store or location or a user heading to the predetermined store or location. As shown in FIG. 4C, the attribute information 423 may include information concerning the general number of users like “large number of people”, information concerning a usage mode like “for drinking parties” or “for dating”, information concerning the sex like “for women”, and information concerning a menu like “sweets”. That is, the attribute information 423 indicates the characteristics of the predetermined store or location, and may include information indicating the current state such as “vacancy”.

In accordance with the analysis result of the image capturing data analysis module 305, the distribution information distribution module 307 selects the distribution information managed by the distribution information management module 306 and distributes it to the user apparatus 30.

The software arrangement of the vehicle 20 according to this embodiment will be described with reference to FIG. 3B. The vehicle 20 implements functions shown in FIG. 3B when the CPU 251 controls the wireless NW IF 256 by executing the program stored in at least one of the ROM 253 and the HDD 254.

The vehicle 20 includes a vehicle information transmission module 351, an instruction reception module 352, and an image capturing data transmission module 353.

The vehicle information transmission module 351 transmits, to the communication server 10, vehicle information including at least one of position information concerning the current position of the vehicle 20 and communication path information concerning a communication environment in association with the identifier of the vehicle 20. For example, the vehicle information transmission module 351 transmits, to the communication server 10, position information acquired from the GPS sensor of the sensor 257 at a predetermined time interval. The vehicle information transmitted by the vehicle information transmission module 351 is used by the vehicle information management module 302 of the communication server 10 to update the vehicle information. The instruction reception module 352 receives an image capturing instruction from the communication server 10. Upon receiving the image capturing instruction, the image capturing unit 255 provided in the vehicle 20 is used to acquire image capturing data. The image capturing data transmission module 353 transmits, to the communication server 10, the image capturing data generated by the image capturing unit 255.

(Processing Sequence)

An example of the processing of the communication system according to this embodiment will be described with reference to FIG. 5.

First, the user apparatus 30 acquires the position information of the user apparatus 30 at a predetermined time interval, and transmits it to the communication server 10 together with the user identifier (S501 and S502). In S502, upon receiving the position information from the user apparatus 30, the communication server 10 updates, based on the position information, the user information DB 400 managed by the user information management module 301. In one example, the user apparatus 30 may start the processing in S501 at a timing of connection to the multi-hop network which the vehicle 20 joins or a timing of connection to the WiFi® network.

The vehicle 20 also acquires the position information of the vehicle 20 at a predetermined time interval, and transmits it to the communication server 10 together with the identifier of the vehicle (S503 and S504). In S504, upon receiving the position information from the vehicle 20, the communication server 10 updates, based on the position information, the vehicle information DB 410 managed by the vehicle information management module 302. In one example, the vehicle 20 may start the processing in S503 when it moves by a predetermined distance or at a timing of connection to a different network.

Subsequently, the communication server 10 specifies, based on the position information of the user apparatus 30 and that of the vehicle 20, the vehicle 20 to which an image capturing instruction is to be transmitted (S505), and transmits the image capturing instruction to the specified vehicle (S506 and S507). The processing in S505 may determine to transmit the image capturing instruction to the vehicle 20 located at a position closest to the position of the user apparatus 30. The image capturing instruction may be transmitted to a plurality of vehicles 20 located within a predetermined distance from the user apparatus 30. This allows the communication server 10 to acquire a plurality of image capturing data concerning the person corresponding to the user apparatus 30, thereby improving the analysis accuracy of the state of the person (to be described later).

In one example, the image capturing instruction may include the location of an image capturing target and the position information of the user apparatus 30. Furthermore, the image capturing instruction may include information for designating an image capturing device to be used by the vehicle 20 to perform image capturing. In this case, in the processing in S505, the communication server 10 may acquire the direction of the user apparatus 30 from the front direction of the vehicle 20 based on the position information of the user apparatus 30 and that of the vehicle 20, and specify, based on the image capturing device information 413, an image capturing device to be used.

Note that the processing in S505 may be executed at a timing when the communication server 10 acquires the position information from the user apparatus 30 or a predetermined timing such as “16:00 every day”.

Upon receiving the image capturing instruction, the vehicle 20 attempts to capture the person corresponding to the user apparatus 30 (S508), and transmits image capturing data to the communication server 10 (S509 and S510). Note that the image capturing data may be image data or moving image data.

The communication server 10 analyzes the image capturing data received in S510, and specifies the state of the person corresponding to the user apparatus 30 at the time of image capturing (S511). The processing in S511 may analyze, based on, for example, image analysis using deep learning, the state of the person at the time of image capturing.

For example, if, as a result of person detection for the image capturing data, one person can be detected, the communication server 10 determines that the detected person is the person corresponding to the user apparatus 30. On the other hand, if a plurality of people can be detected, the communication server 10 determines which of the detected people is the person corresponding to the user apparatus 30. For example, based on the basic information 403 of the user information and the basic information 403 of the person corresponding to the user apparatus 30, the person corresponding to the user apparatus 30 may be specified from the plurality of detected people.

Subsequently, the operation of the person such as standing, sitting, walking, or running is specified. Note that if the detected person is moving, a moving direction may be specified. This makes it possible to specify, based on the position of the user apparatus 30 and the detected moving direction, a position where the person corresponding to the user apparatus 30 is expected to reach.

Furthermore, the communication server 10 may analyze the facial expression of the detected person to specify the feeling such as a smile or anger or the state such as fatigue, or may specify the clothing of the detected person.

Note that if, as a result of performing image analysis of the image capturing data, a plurality of people are detected, the communication server 10 may determine, in accordance with the state of the plurality of people, that they are a group of people. For example, if the distance among the plurality of people is equal to or shorter than a predetermined value, the plurality of people may be grouped. This can specify to distribute the distribution information having the attribute “large number of people” of the identifier d1 in accordance with the number of people of the group. If the plurality of people are performing an action of holding hands or arms, it may be determined that they are a group of people. Alternatively, based on face directions and lines of sight, for example, the fact that the plurality of people are looking at each other, it may be determined that they are a group of people.

Subsequently, based on the state of the person specified in S511, the communication server 10 selects distribution information to be distributed (S512). For example, if the detected person is standing or sitting and does not move, the communication server 10 may select distribution information having, as an attribute, a position close to the position of the user apparatus 30. If the detected person is moving, the communication server 10 may select distribution information having, as an attribute, a position close to a position (planned movement location) where the person is expected to reach. This can select information concerning a store or location where the user of the user apparatus 30 easily stops by.

Distribution information may be selected in accordance with whether the detected person is with someone. For example, if the detected person does not belong to any group, distribution information concerning a movie theater, a book store, a ramen shop, or the like may be selected; otherwise, distribution information concerning a cafe, a karaoke box, a pub, or the like may be selected. If the number of people of the group to which the specified person belongs is larger than a predetermined number, information of a store suitable for a large number of people is selected to be distributed. This can distribute appropriate distribution information in accordance with the number of people of the group to which the detected person belongs.

Furthermore, if the facial expression of the detected person indicates anger, the communication server 10 may select distribution information concerning a gym. If the facial expression of the detected person indicates sadness, the communication server 10 may select distribution information concerning a cafe. This can distribute appropriate distribution information in accordance with the mental state of the detected person.

Note that one or a plurality of pieces of distribution information may be selected in S512.

Subsequently, the communication server 10 transmits, to the user apparatus 30, the distribution information selected in S512 (S513 and S514). Note that FIG. 5 shows the processing by assuming that the communication server 10 directly transmits the distribution information to the user apparatus 30. However, control may be executed to transmit the distribution information to the vehicle 20, and then transfer the distribution information from the vehicle 20 to the user apparatus 30 via the multi-hop network.

### Other Embodiments

The present invention is not limited to the above-described embodiment and various modifications and changes can be made within the spirit and scope of the present invention.

For example, the first embodiment has explained the example in which the communication server 10 specifies the vehicle 20 located in the periphery of the specific user apparatus 30, and selects, based on the state of the user of the user apparatus 30, distribution information to be distributed. However, in one example, the communication server 10 may acquire image capturing data captured by the specific vehicle 20 such as the randomly selected vehicle 20 at a predetermined period, specify the user apparatus 30 based on the position of the vehicle 20, and select, based on the state of the user of the user apparatus 30 located in the periphery of the vehicle 20, distribution information to be distributed. In this case, specifying the vehicle in S505 of FIG. 5 and transmitting the image capturing instruction in S506 of FIG. 5 may be skipped.

Alternatively, for example, the communication server 10 may select distribution information based on information concerning whether a store is open, a congestion condition such as the seat availability of the store, the limited-time sale or limited-time menu of the store, and the like. For example, if an information processing apparatus (not shown) installed in a store can acquire information (seat availability information) concerning the seat availability of the store from sensors installed in seats, the communication server 10 may collect seat availability information at a predetermined period from the information processing apparatus installed in the store, and periodically update the distribution information 422 and attribute information 423 shown in FIG. 4C. In this case, when selecting distribution information in S512, distribution information may be selected based on the seat availability information, for example, distribution information may be selected under the condition that there is a vacant seat. In one example, if the person detected in S511 belongs to a group, distribution information may be selected in S512 under the condition that the number of vacant seats is larger than the number of people of the group.

The communication server 10 according to this embodiment specifies the vehicle in S505 based on the positions of the vehicle 20 and the user apparatus 30. However, if the vehicle 20 operates as a node in the multi-hop network or an access point of a star network, and the user apparatus 30 joins the same network as that of the vehicle 20, the vehicle may be specified in S505 based on the network information of the vehicle 20 and the user apparatus 30.

Furthermore, at least one of the functions of the communication server 10 according to this embodiment may be implemented by the vehicle 20 or an external apparatus. For example, the user information management module 301, the vehicle information management module 302, and the distribution information management module 306 may be implemented by an external apparatus. Alternatively, for example, when the vehicle 20 acquires image capturing data, the vehicle 20 may analyze the state of a person included in the image capturing data using the CPU 251 of the vehicle 20, and transmit analysis data including information concerning the state of the person to the communication server 10, and then the communication server 10 may select distribution information based on the analysis data and distribute it. That is, the vehicle 20 may include a component corresponding to the image capturing data analysis module 305 and an analysis data transmission unit. This can reduce the processing load of the communication server 10.

### Summary of Embodiments

1. An information processing apparatus (for example, a communication server 10, a combination of the communication server 10 and a vehicle 20) according to the above embodiment is an information processing apparatus for distributing distribution information to a user apparatus, comprising:

first specifying unit (for example, an image capturing data analysis module 305) for specifying, based on image capturing data acquired by an image capturing device of a vehicle, a state of a person associated with the user apparatus (for example, a user apparatus 30) at the time of image capturing; and

distribution unit (for example, a distribution information distribution module 307) for distributing, to the user apparatus, distribution information selected from a plurality of pieces of distribution information based on the state of the person specified by the first specifying unit.

This can distribute appropriate information in accordance with the state of the person.

2. The information processing apparatus according to the above embodiment further comprises

second specifying unit (for example, a vehicle specifying module 303) for specifying a vehicle that instructs to perform image capturing of the person associated with the user apparatus, and

instruction unit (for example, an image capturing instruction transmission module 304) for instructing the vehicle specified by the second specifying unit to perform image capturing.

This can distribute appropriate information in accordance with the state of the person associated with the user apparatus.

3. The information processing apparatus according to the above embodiment further comprises first acquisition unit (for example, a vehicle information management module 302) for acquiring information concerning a network to which the vehicle and the user apparatus are connected, and

the instruction unit instructs the vehicle connected to the same network as the network of the user apparatus to perform image capturing.

This can distribute information to the person having the user apparatus that receives provision of network connection by the vehicle.

4. In the information processing apparatus according to the above embodiment,

the state of the person includes at least one of an operation executed by the person, a facial expression of the person, clothing of the person, and the number of people acting with the person.

This can distribute appropriate information in accordance with a state such as the operation of the person, the facial expression, the clothing, and the group to which the person belongs.

5. The information processing apparatus according to the above embodiment further comprises first acquisition unit (for example, a user information management module 301, the vehicle information management module 302) for acquiring pieces of position information of the vehicle and the user apparatus, and

the instruction unit instructs the vehicle, located at a position closest to the user apparatus, to perform image capturing.

This can distribute information to the person having the user apparatus close to the vehicle.

6. The information processing apparatus according to the above embodiment further comprises first acquisition unit (for example, a user information management module 301, the vehicle information management module 302) for acquiring pieces of position information of the vehicle and the user apparatus, and

the instruction unit instructs the vehicle, located at a position closest to the user apparatus, to perform image capturing.

This can specify the state of the person based on the image capturing data from the vehicle located at the close position.

7. In the information processing apparatus according to the above embodiment,

the state of the person includes at least one of an operation executed by the person, a facial expression of the person, clothing of the person, and the number of people acting with the person.

This can distribute appropriate information in accordance with the state such as the operation of the person, the facial expression, the clothing, and the group to which the person belongs.

8. In the information processing apparatus according to the above embodiment,

the distribution unit selects and distributes, if the state of the person indicates that the person is not moving, distribution information corresponding to a store located within a predetermined distance from a position of the user apparatus, and

the distribution unit selects and distributes, if the state of the person indicates movement of the person, distribution information corresponding to a store located within a predetermined distance from a planned movement location of the person.

This can distribute information concerning a store where the person easily stops by.

9. In the information processing apparatus according to the above embodiment, the instruction unit further instructs an image capturing device to be used for image capturing.

This can instruct the image capturing device to be used to capture the person, and distribute appropriate information in accordance with the state of the captured person.

10. In the information processing apparatus according to the above embodiment, the distribution unit

transmits the distribution information to the vehicle, and

controls to cause the vehicle to transmit the distribution information to the user apparatus via a network to which the vehicle is connected.

This can suppress the communication cost of the user apparatus.

11. In the information processing apparatus according to the above embodiment,

the distribution information is advertisement information concerning a store located within a predetermined distance from the user apparatus.

This can distribute appropriate advertisement information in accordance with the state of the person.

12. The information processing apparatus according to the above embodiment further comprises third acquisition unit for acquiring basic information concerning an appearance of a user of the user apparatus, and

the second specifying unit specifies the state of the person associated with the user apparatus based on a result of image analysis of the image capturing data and the basic information acquired by the third acquisition unit.

This can accurately specify the state of the person.

13. The information processing apparatus according to the above embodiment further comprises collection unit for collecting seat availability information of a store at a predetermined period, and

the distribution unit distributes the distribution information specified further based on the seat availability information.

This can prevent the person from heading to a store that is full.

14. An information processing method according to the above embodiment is an information processing method executed in an information processing apparatus for distributing distribution information to a user apparatus, comprising:

a first specifying step of specifying, based on image capturing data acquired by an image capturing device of a vehicle, a state of a person associated with the user apparatus at the time of image capturing; and

a distribution step of distributing, to the user apparatus, distribution information selected from a plurality of pieces of distribution information based on the state of the person specified in the first specifying step.

This can distribute appropriate information in accordance with the state of the person.

### REFERENCE SIGNS LIST

1: communication system, 10: communication server, 20: vehicle, 30: user apparatus

What is claimed is:

1. An information processing apparatus for distributing distribution information to a user apparatus, the information processing apparatus executing an information processing method comprising:
specifying, based on image capturing data acquired by an image capturing device of a vehicle, a state of a person associated with the user apparatus at the time of image capturing; and
distributing, to the user apparatus, distribution information selected from a plurality of pieces of distribution information based on the specified state of the person.

2. The apparatus according to claim 1, wherein the information processing method further comprises
specifying a vehicle that instructs to perform image capturing of the person associated with the user apparatus, and
instructing the specified vehicle to perform image capturing.

3. The apparatus according to claim 2, wherein
the information processing method further comprises acquiring information concerning a network to which the vehicle and the user apparatus are connected, and
in the instructing, the vehicle connected to the same network as the network of the user apparatus is instructed to perform image capturing.

4. The apparatus according to claim 3, wherein the state of the person includes at least one of an operation executed by the person, a facial expression of the person, clothing of the person, and the number of people acting with the person.

5. The apparatus according to claim 2, wherein
the information processing method further comprises acquiring pieces of position information of the vehicle and the user apparatus, and
the instructing includes instructing the vehicle, located at a position closest to the user apparatus, to perform image capturing.

6. The apparatus according to claim 5, wherein
the distribution information is associated with attribute information concerning a position of a store, and
the distributing includes selecting and distributing distribution information based on a position of the user apparatus and the position of the store.

7. The apparatus according to claim 5, wherein the state of the person includes at least one of an operation executed by the person, a facial expression of the person, clothing of the person, and the number of people acting with the person.

8. The apparatus according to claim 7, wherein
the distributing includes selecting and distributing, if the state of the person indicates that the person is not moving, distribution information corresponding to a store located within a predetermined distance from a position of the user apparatus, and
the distributing includes selecting and distributing, if the state of the person indicates movement of the person, distribution information corresponding to a store located within a predetermined distance from a planned movement location of the person.

9. The apparatus according to claim 2, wherein the instructing includes further instructing an image capturing device to be used for image capturing.

10. The apparatus according to claim 1, wherein the distributing includes
transmitting the distribution information to the vehicle, and
controlling to cause the vehicle to transmit the distribution information to the user apparatus via a network to which the vehicle is connected.

11. The apparatus according to claim 1, wherein the distribution information is advertisement information concerning a store located within a predetermined distance from the user apparatus.

12. The apparatus according to claim 1, wherein
the information processing method further comprises acquiring basic information concerning an appearance of a user of the user apparatus, and
the specifying the state of the person associated with the user apparatus at the time of image capturing includes specifying the state of the person associated with the user apparatus based on a result of image analysis of the image capturing data and the acquired basic information.

13. The apparatus according to claim 1, wherein
the information processing method further comprises collecting seat availability information of a store at a predetermined period, and
the distributing includes distributing the distribution information specified further based on the seat availability information.

14. An information processing method executed in an information processing apparatus for distributing distribution information to a user apparatus, comprising:
specifying, based on image capturing data acquired by an image capturing device of a vehicle, a state of a person associated with the user apparatus at the time of image capturing; and
distributing, to the user apparatus, distribution information selected from a plurality of pieces of distribution information based on the specified state of the person.

15. A non-transitory computer-readable storage medium storing a program for causing a computer to execute each step of an information processing method according to claim 14.
